(19) United States
(12) Patent Application Publication
(10) Pub. No.: US 2017/0201721 A1
(43) Pub. Date: Jul. 13, 2017

(54) ARTIFACT PROJECTION

(71) Applicant: HEWLETT PACKARD ENTERPRISE DEVELOPMENT LP, Houston, TX (US)

(72) Inventors: Joshua HAILPERN, Sunnyvale, CA (US); William J. ALLEN, Corvallis, OR (US); James C. COOPER, Blomington, IN (US); Kieran MCCORRY, Belfast (GB)

(73) Assignee: HEWLETT PACKARD ENTERPRISE DEVELOPMENT LP, Houston, TX (US)

(21) Appl. No.: 15/306,564

(22) PCT Filed: Sep. 30, 2014
(86) PCT No.: PCT/US2014/058377

§ 371 Date: Oct. 25, 2016

(51) Int. Cl. H04N 7/15; G06F 3/0481; H04L 29/06; H04M 3/56; H04L 12/18; G06F 3/14; H04N 7/14

(52) U.S. Cl. CPC H04N 7/157; G06F 3/1454; G06F 3/0481; H04N 7/147; H04M 3/567; H04L 12/1831; H04L 65/601

(57) ABSTRACT

Systems and methods associated with artifact projection are disclosed. One example method includes generating a first digital object in a virtual space. The first digital object may correspond to a first artifact in a first physical space. The method also includes recording attributes of the first artifact as the attributes change over time. The attributes may be recorded in association with the first digital object. The method also includes projecting a representation of the first digital object into a second space. The representation may be generated based on of the first artifact at a first selected time.

### BACKGROUND

There are two main ways that meetings take place, depending primarily on whether there is a single, appropriate space that is accessible to all parties. If such a space is available, the meeting may be held in that space. If such a space is not available, (e.g., because all available spaces are too small to fit all parties, the parties are spread across great distances), then some form of teleconferencing system may be used. These teleconferencing systems work by transmitting, for example, video, slides, audio, and so forth, to other locations simultaneously so that participants can engage in synchronous communication.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 illustrates example rooms, people, and artifacts on which example systems and methods, and equivalents may operate.

FIG. 2 illustrates a flowchart of example operations associated with artifact projection.

FIG. 3 illustrates another flowchart of example operations associated with artifact projection.

FIG. 4 illustrates another flowchart of example operations associated with artifact projection.

FIG. 5 illustrates another example system associated with artifact projection.

FIG. 6 illustrates another flowchart of example operations associated with artifact projection.

FIG. 7 illustrates an example computing device in which example systems and methods, and equivalents, may operate.

### DETAILED DESCRIPTION

Systems and methods associated with artifact projection are described. In various examples, artifact projection may be achieved by storing, in a virtual space, a digital object associated with a physical artifact in a first physical location. A physical artifact may include, for example, physical objects and digital content elements available for interaction in the physical location (e.g., slide presentation, notes on a whiteboard). The physical location may be a meeting space in which persons may interact with one or more physical artifacts. A representation of the artifact may then be projected into a second location (e.g., the first physical location, a second physical location, a virtual projection) either substantially simultaneously with the recording or at a later point in time. The digital object may be used to preserve state changes to, manipulations of, and interactions with the physical artifact and/or its projection over time. This may allow these changes, manipulations, and/or interactions to be replayed as a part of projecting the representation of the artifact. Preserving and facilitating review of these changes, manipulations, and interactions may allow a team working on a project to review, for example, previous decisions and/or discussions regarding an artifact, a project to which the artifact relates, and so forth.

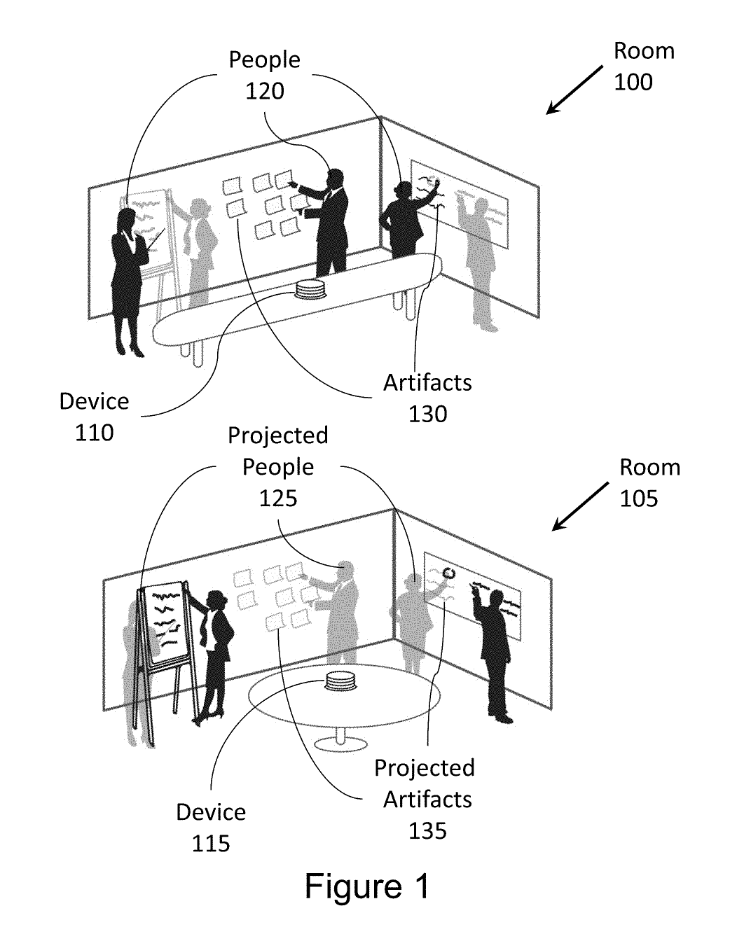

FIG. 1 illustrates example rooms, people, and artifacts on which example systems and methods, and equivalents may operate. It should be appreciated that the items depicted in FIG. 1 are illustrative examples and many different features and implementations are possible.

FIG. 1 illustrates two rooms 100 and 105. These rooms may be, for example, conference rooms in different locations. Room 100 contains a device 110, and room 105 contains a device 115. Though FIG. 1 illustrates one example manner of operation of devices 110 and 115 relating to a synchronous meeting, other possible uses of devices 110 and 115 (e.g., subsequent meetings, individual reviews) are also possible and described below.

Devices 110 and 115 may contain equipment for recording events in their respective rooms (e.g., video cameras), and equipment (e.g., projectors) for projecting artifacts 130, people 120, and interactions occurring in other rooms. In some examples, devices 110 and 115 may also contain memory for storing information associated with artifacts 130, communication equipment (e.g., network card, Bluetooth functionality) to facilitate transmitting information associated with artifacts 130, and so forth.

In FIG. 1, devices 110 and 115 are illustrated as seated atop respective tables within rooms 100 and 105. In this example, devices 110 and 115 may be mobile units that can be transported from conference room to conference room as necessary and seated atop tables. This may allow essentially any space to be converted into a meeting room to handle relocations, space availability issues, and so forth. In another example, devices 110 and 115 may be built into the conference room allowing the creation of designated collaboration rooms. Though designated collaboration rooms may create a limited resource that is competed over by various projects within an organization, there may be reasons for using designated collaboration rooms over mobile units. For example, a room built to house a device may be able to be designed to better accommodate recording and/or projection equipment. For example, projectors hung from the ceiling may create larger projections than one placed on a surface (e.g., a table) within a room. Further, for the purpose of this application, projection may be functionally equivalent to display, as an artifact projected onto a segment of a wall, may be functionally equivalent to an artifact displayed on a monitor on a wall instead. Additionally, a designated space may be designed so that surfaces within the room are more amenable to preserving spatial relationships of artifacts within a digital representation of the room.

Between rooms 100 and 105, five people 120 are having a meeting discussing a topic (e.g., a project, a problem, a product). Three of the people 120 are in room 100, and two of the people 120 are in room 105. Additionally, the people 120 may be discussing various artifacts 130 throughout the room. In FIG. 1, items (e.g., device 110, artifacts 130) and people 120 actually in a room are indicated using black, and items projected into a room (e.g., projected people 125, projected artifacts 135) are indicated in gray.

In this example, the artifacts in room 100 include notes attached to a wall and a dry-erase board. Artifacts in room 105 include a flip-chart on an easel and a dry-erase board. Though several textual artifacts are illustrated, digital artifacts (e.g., projected slides), people (e.g., people 120), physical objects (e.g., a product demo) could also be treated as artifacts by devices 110 and 115.

Using recording equipment, device 110 may record interactions of people 120 with artifacts 130 in room 100. These interactions may include, modifying artifacts 130, creating artifacts 130, removing artifacts 130, discussing artifacts 130, and so forth. These interactions may then be transmitted from device 110 to device 115 (e.g., over the Internet). Device 115 may then generate projections of the people 120 in room 100 as projected people 125 in room 105. Device 115 may also generate projections of the artifacts 130 in room 100 as projected artifacts 135 in room 105.

By way of illustration, consider the person in room 120 interacting with the notes attached to the wall. In one example, each note may be treated as an individual artifact. If the person interacting with the notes rearranges the notes or modifies a note (e.g., by writing on the note), device 110 may record these interactions and/or modifications and cause these modifications to be transmitted to and projected by device 115 into room 105.

Similarly, device 115 may use recording equipment to record interactions of people 120 in room 105 with artifacts 130 in room 105, which may be transmitted to and projected by device 110 into room 100.

In other examples, device 110 may facilitate projection of artifacts 130 and/or interactions with artifacts 130 at a later time and/or in a different room. By way of illustration, if the people 120 in room 100 have time limited schedules but plan to reconvene the next day in a different room, device 110 may allow the people 130 to resume their meeting by projecting representations of the artifacts 130 into the different room. Consequently, because the different room may have different features (e.g., the different room has windows while room 100 does not), device 100 may identify suitable locations within the different room at which to project the representations. This may preserve meeting states over time so that meetings regarding projects can continue where they left of and so artifact states and/or discussions may be reviewed as necessary.

These features may add additional functionality beyond some meeting room setups involving a set of video recording equipment and either a set of displays (e.g., televisions, monitors) or projectors. Though these meetings in these types of rooms may be recorded, they do not individually track components over time and preserve state changes. Consequently, such a setup, if recording functionality exists at all, might require replaying everything going on in one of these rooms, without being able to separate and control review of individual components on their own. Similarly, preserving a meeting state at the end of a meeting, if certain artifacts need to be preserved, may require maintaining the artifacts individually by removing them from the room and physically storing the artifacts, as opposed to storing the artifacts digitally so that they may be automatically recovered.

The capture and projection of interactions with and state changes of artifacts in room 100 may be facilitated by use of a virtual space and a set of digital objects associated with artifacts 130 in room 100. In one example, the virtual space may be maintained within device 110 and/or device 115. In another example, the virtual space may be maintained in a server in communication with devices 110 and 115. In either case, many virtual spaces may be maintained and each virtual space may be associated with a given project, topic, product, and so forth. Thus, when a team working on, for example, a given project concludes a meeting and later reconvenes, artifacts from the concluded meeting may be quickly recovered by loading the appropriate virtual space and projecting associated artifacts into the new meeting location. Consequently, any given device 110 may, at various times, be associated with different virtual spaces, and associations between a virtual space, a device 110, and a room may or may not be maintained.

To facilitate reconstruction of artifacts into the new meeting location, each digital object associated with a given virtual space may be given a “location” within the virtual space. The location within the virtual space may facilitate preservation of, for example, relative spatial relationships between artifacts over time.

As an artifact is interacted with and modified over time, the interactions and attributes may be recorded by device 110 and associated with a corresponding digital object. When a representation of the artifact is ultimately projected, the representation projected may be associated with a specific state or interaction so that prior states of the artifact may be reviewed. This may facilitate reviewing discussions relating to the artifact and/or changes made to the artifact over time.

In one example, instead of a physical location, it may be desirable to project the virtual space as a virtual rendering of the virtual space. This virtual rendering may be, for example, a 2D or 3D representation of the virtual space that a person can view using their personal computer. Using a virtual rendering may be desirable when, for example, a person working on a project wants to review modifications to and/or interactions with an artifact without requiring a physical location (e.g., room) into which to project an artifact 130. Similarly, a virtual rendering may allow a person to participate in, attend, and/or interact with artifacts in a live meeting without requiring that person to obtain a physical space. In another example, a person may be able to interact with the virtual space projected onto a near-to-eye display (e.g., using virtual reality technologies).

Various techniques may be used by people 120 to interact with device 110 for the purpose of designating artifacts in room 100 and/or interacting with the artifacts in a manner that will be preserved by device 110. By way of illustration, having specified commands for controlling device 110 may prevent device 110 from inadvertently treating room decorations or unrelated materials within room 100 as relevant artifacts 130 to be preserved and projected.

These commands, may include, for example, gesture commands, oral commands, commands received from input devices, and so forth. Gesture commands may be detected using, for example, the recording devices being used to track interactions with artifacts, skeleton tracking, and so forth. Oral commands may be detected using, for example, a microphone within device 110. Input devices may include, for example, pointer devices (e.g., laser pointer), wearable technology, tablets, personal computers, other computing devices, and so forth. In some cases, smart technology (e.g., Bluetooth enabled touch screen) may also facilitate command input to device 110. Contextual information may also be considered by device 110. By way of illustration, if a participant begins interacting with an item in a physical location not previously treated as an artifact, device 110 may create a digital object associated with the item and begin treating the item as an artifact.

It is appreciated that, in the following description, numerous specific details are set forth to provide a thorough understanding of the examples. However, it is appreciated that the examples may be practiced without limitation to these specific details. In other instances, methods and structures may not be described in detail to avoid unnecessarily obscuring the description of the examples. Also, the examples may be used in combination with each other.

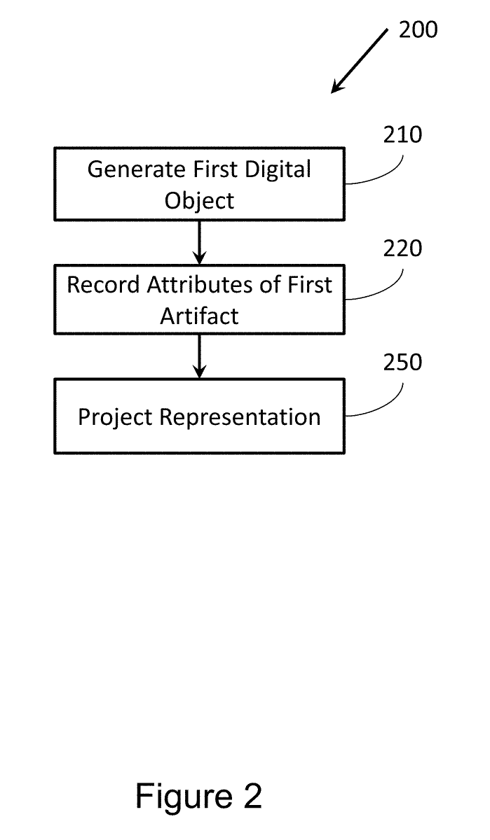

FIG. 2 illustrates a method 200 associated with artifact projection. Method 200 may be embodied on a non-transitory computer-readable medium storing computer-executable instructions. The instructions, when executed by a computer may cause the computer to perform method 200.

Method 200 includes generating a first digital object at 210. The first digital object may be generated within a virtual space. In one example, the virtual space and the first digital object may essentially be data elements used to represent a room and an object within the room. Consequently, the virtual space may “contain” several digital objects including the first digital object. In one example, digital objects may have “locations” within the digital space. These locations may be represented by coordinates within the digital space. In an alternative example, digital objects may merely be associated with a digital space without a specific location within the digital space. In this example, when digital objects are identified as having a spatial relationship to other digital objects, these spatial relationships may be preserved.

The first digital artifact may correspond to a first artifact. The first artifact may reside within a first physical space (e.g., a conference room). The first artifact may be, for example, a physical object, a digital content element, a person, and so forth. A physical object may be an actual object within a room with which people in the room are interacting. Consequently, physical objects may include, for example, whiteboards, blackboards, note boards, easels, product samples, note cards, and so forth. Digital content elements may be content elements that do not exist physically in the room, but are, for example, projected into the room. Thus, a slide show may be one example of a digital content element. In one example, people within the room may also be treated as artifacts to facilitate storing and re-projection of discussions and manipulations of other artifacts. In another example, when text is written on a surface (e.g., a piece of paper attached to a wall, an erasable surface) the text may be treated as an artifact rather than the surface).

Method 200 also includes recording attributes of the first artifact at 220. The attributes may be recorded, for example, using cameras, microphones, and/or other technologies appropriate for storing information. For example, a Wi-Fi or Bluetooth enabled smart-board may facilitate recording attributes of artifacts drawn and/or written onto the smart-board. The attributes may be recorded as the attributes of the first artifact change over time. Recording attributes over time may facilitate re-projection of the modifications over time so that later viewers can review the context of modifications to an artifact. The attributes may be recorded using the first digital object. Recording attributes on an artifact by artifact basis and storing the attributes with a respective digital object may allow modifications to individual artifacts to be reviewed over time independently of one another. This may allow review of state changes of individual artifacts without having to replay everything that happened during the time period when the state changes occurred.

Method 200 also includes projecting a representation of the first artifact at 250. The representation may be projected into a second space. The representation may be generated based on attributes of the first artifact at a first selected time. The representation of the first artifact may be projected into the second space based on one or more of, for example, a gesture command, an oral command, a command received from an input device, and so forth. These commands may identify, for example, the digital space, the artifact, the digital object, the selected time, a physical location at which the representation is to be projected, and so forth.

In one example, the first physical space and the second space may be the same physical space at different points in time. In this example, representations of artifacts may be projected back to their original locations within the physical space. In another example, the first physical space and the second space may be different physical spaces. In this example, projecting the representation of the first artifact at 230 may occur substantially contemporaneously with recording the attributes of the first artifact at 220. This may allow two groups of users in different locations to manipulate and/or interact with artifacts substantially simultaneously.

In another example, the second space may be a virtual rendering of the first physical space. This may allow a person using a personal computer to review modifications and/or interactions with artifacts without, for example, occupying a conference room. The virtual rendering may also be generated substantially simultaneously with the recording of attribute changes of artifacts, potentially allowing a user viewing the virtual rendering to participate in discussions regarding artifacts in the first physical space in real time (e.g., view artifacts, manipulate artifacts using an interface in the virtual rendering).

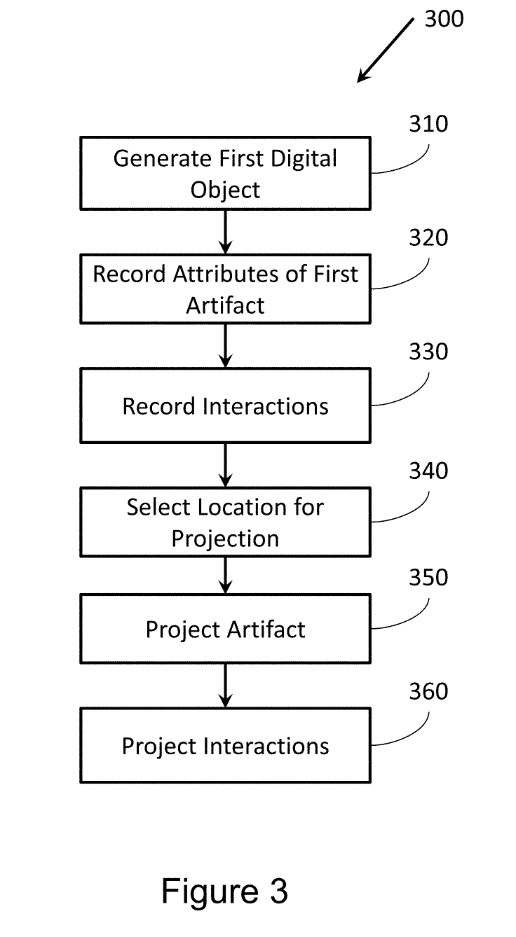

FIG. 3 illustrates a method 300 associated with artifact projection. Method 300 includes several actions similar to those described above with reference to method 200 (FIG. 2). For example, method 300 includes generating a first digital object at 310, recording attributes of a first artifact at 320, and projecting a representation of the first artifact at 350 based on attributes of the artifact at a first selected time.

Method 300 also includes recording interactions with the first artifact over time at 330. In one example, interactions may be recorded using, for example, video recording equipment. In another example, interactions may be recorded based on signals received from artifacts with which a user is interacting. For example, if a user is typing into a keyboard, the keyboard may report the keys the user is pressing. If the user is interacting with a smart-board, the smart board may store and transmit the user's interactions with the smart board. Artifacts configured to record and report user interactions may be more reliable than video recording equipment because video recording equipment may have its field of view blocked, potentially preventing recording of interactions.

Method 300 also includes projecting the interactions with the first artifact at 360. These interactions may include, for example, commands input by persons attempting to manipulate the first artifact, discussions regarding the first artifact, in person references to the first artifact (e.g., pointing at the first artifact), and so forth. The interactions may be projected into a second space. Projecting interactions into a second space may effectively project a representation of the person interacting with the first artifact. This may allow people in the first physical space and the second space to interact with one another and/or artifacts in both spaces. The interactions projected may correspond to the first selected time. This may facilitate recording and re-projecting of interactions with artifacts. The first selected time may correspond to a selected prior state of the first artifact. Thus, the first selected time may be selected by selecting a prior state of the first artifact.

Method 300 also includes selecting a suitable location within the second space at 340. The suitable location may be selected as a location at which the representation of the first artifact will be projected. This may be necessary if, for example, the second space does not have the same physical attributes as the first space. By way of illustration, if the first physical space is an internal room with no windows, but the second space is an exterior room with windows along one wall, representations of artifacts that would be projected into the windowed wall may need to be projected into a different location in the second space. This may cause other representations to be relocated accordingly. In some examples, the representation of the first artifact may also need to be adjusted to fit within the suitable location. This may be necessary when, for example, a spatial relationship between the first artifact and another artifact needs to be preserved but there is not sufficient space (e.g., walls onto which a suitable projection may be made) within the second space.

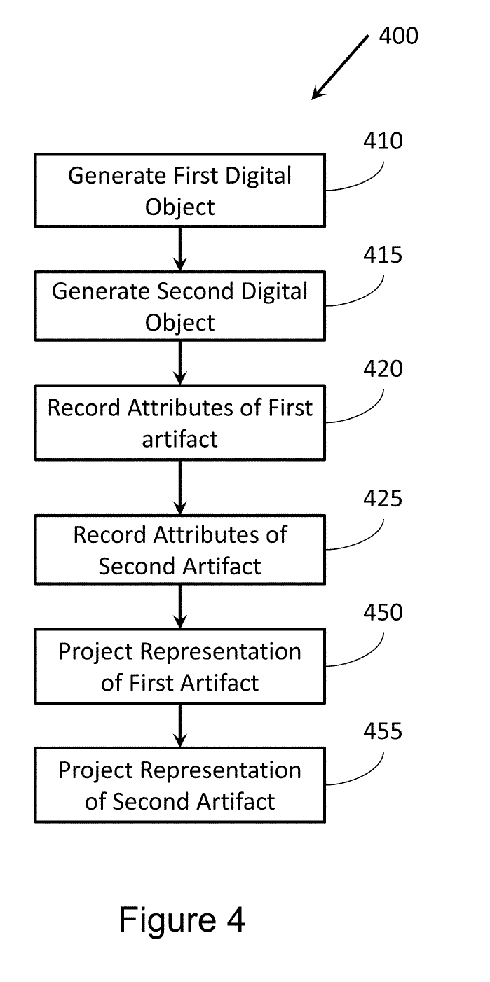

FIG. 4 illustrates a method 400 associated with artifact projection. Method 400 includes several actions similar to those described above with reference to method 200 (FIG. 2). For example, method 400 includes generating a first digital object in a virtual space at 410, recording attributes of a first artifact at 420, and projecting a representation of the first artifact into a second space at 450.

Method 400 also includes generating a second digital object in the virtual space at 415. The second digital object may correspond to a second artifact in the second space. Method 400 also includes recording attributes of the second artifact at 425. The attributes may be recorded as they change over time, and may be recorded using the second digital object.

Method 400 also includes projecting a representation of the second artifact into the first physical space at 455. The representation may be generated based on attributes of the second artifact. In one example, the representation of the second artifact may be projected into the first physical space based on attributes of the second artifact at a second selected time. Using method 400, the situations depicted in rooms 100 and 105 (FIG. 1) may be implemented. Thus, two groups of people in meeting rooms potentially separated by large geographic distances can collaborate on a project where artifacts and persons in each room are projected into the other room. This may potentially be extended into more than two rooms, further facilitating collaboration when all relevant attendees cannot meet in the physical same location.

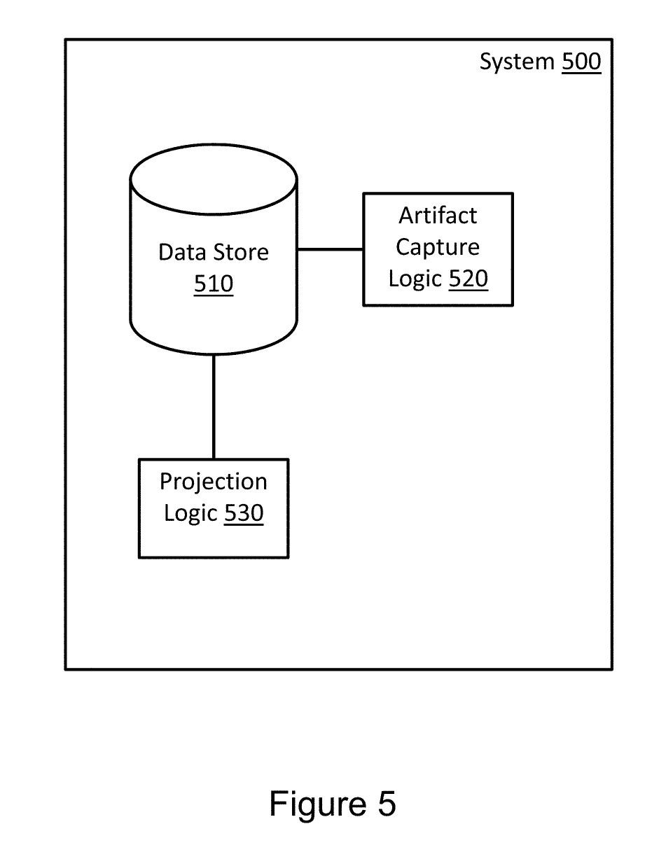

FIG. 5 illustrates a system 500 associated with artifact projection. System 500 includes a data store 510. Data store 510 may store a first digital space and a first digital object. The first digital object may be associated with a first artifact having a first location in a first physical space. As mentioned above, the first artifact may be, for example, a physical object, a digital content element, a person, and so forth. The first location may correspond to a first digital location in the first digital space. The first location may be a relative location, an absolute location, and so forth and may be based, for example, on dimensions of the first physical space, distance from another artifact within the first physical space, distance from a representation of another artifact projected into the first physical space, a relationship to a device (e.g., a device embodying system 500) within the first physical space, and so forth.

System 500 also includes an artifact capture logic 520. Artifact capture logic 520 may identify manipulations made to the first artifact over time. Artifact capture logic 520 may also store the manipulations as states associated with the first digital object. Storing the manipulations of the first artifact as states associated with the first digital object may facilitate recovering the prior states and manipulations for subsequent review.

System 500 also includes a projection logic 530. Projection logic 530 may generate a projection of the first artifact at a first projection location. The first projection location may be a location in the first physical space, a location in another physical space, a location in a virtual representation of the digital space, and so forth. The projection may be generated based on a state associated with the first digital object. Thus, upon selecting a state of the first digital object, a projection of the first artifact may be projected for review. In one example, system 500 may be controllable to step through projections of the states, allowing modifications to the first artifact over time to be reviewed.

In one example, data store 510 may also store a second digital object. The second digital object may be associated with a second artifact having a second physical location in a second physical space. The second physical location may correspond to a second digital location in the first digital space. The first digital location and the second digital location preserve a relative spatial relationship between the first artifact and the second artifact. In this example, projection logic 530 may generate a second artifact at a second projection location. The first projection location and the second projection location may preserve the relative spatial relationship between the first artifact and the second artifact. In other examples, the first digital location and the second digital location may be uncorrelated.

In another example, data store 510 may also store a second digital space. In this example, the first digital space may be associated with a first project, and the second digital space may be associated with a second project. In alternative examples, the digital spaces may be associated with topics, products, and so forth. Projection logic 530 may be controllable to switch between projections of artifacts associated with the first digital space and projections of artifacts associated with the second digital space. This may allow users of system 500 to switch between digital spaces and store information regarding artifacts separately between the digital spaces.

In one example, system 500 may be implemented within a device which also includes projection and video/audio recording equipment, similar to devices 110 and 115 described above with reference to FIG. 1. In this example, the device may contain a memory that contains data store 510, and a processor that manages projection logic 530 and artifact capture logic 520. In another example, system 500 may be implemented in a server that controls a device (e.g., device 110, device 115) and receives video and/or audio input from the device. In this case, the server may house various logics for differentiating between artifacts, and for controlling the capture and projection of the artifacts. Combinations of these two examples with varying degrees of functionality embodied on a server and on a device may also be appropriate.

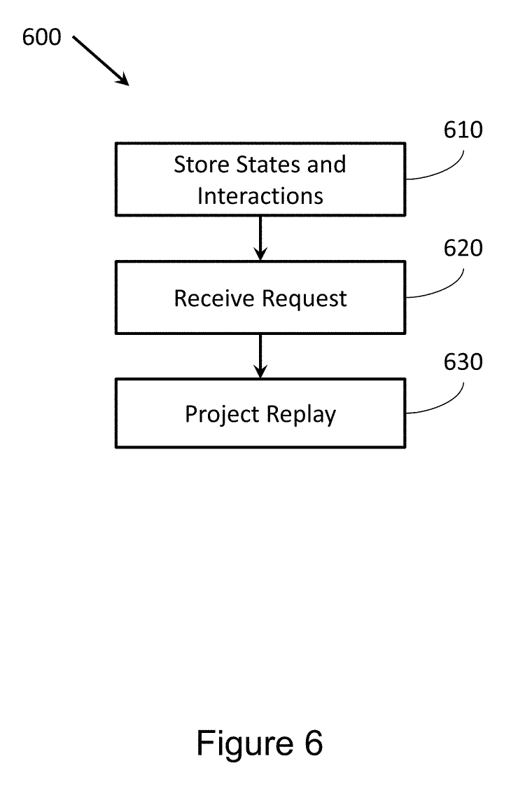

FIG. 6 illustrates a method 600 associated with artifact projection. Method 600 includes storing states and interactions at 610. The states and interactions may be associated with artifacts at locations in a physical space. The artifacts may be, for example, physical objects, digital content elements, persons, and so forth. The interactions may be, for example, discussions, commands, modifications, and so forth associated with the artifacts. The locations in the physical space may correspond to digital locations in a virtual space. Locations may be, for example, absolute locations based on a specific point in space, relative locations compared to other artifacts to preserve spatial relationships, and so forth.

Method 600 also includes receiving a request at 620. The request may indicate an artifact and one or more of a state and an interaction. Thus, the request may be used to identify an artifact and a state of the artifact or an interaction with the artifact that a person would like to review. In some cases, where method 600 is being used to facilitate synchronous communication, the signal may identify the current state of all artifacts, potentially causing the current state of all artifacts associated with a digital space to be retrieved.

Method 600 also includes projecting a replay of the artifact at 630. The replay may be projected onto a projected location. The projected location may be a in the physical space, in a different physical space, in a virtual representation of the digital space, in a virtual representation of the physical space, and so forth. The replay may be associated with one or more of the state and the interaction. Thus, the replay may allow review of the states of the artifact over time.

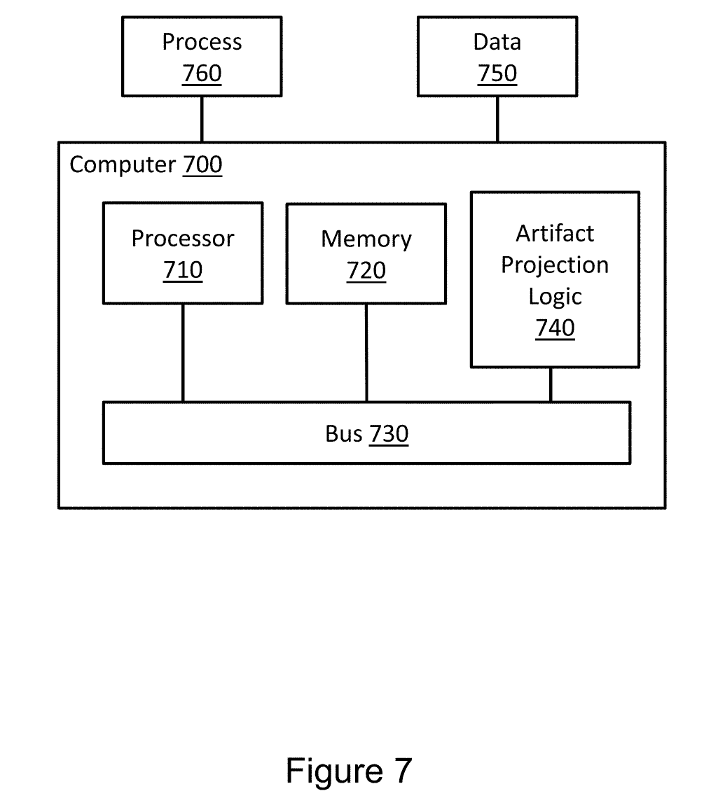

FIG. 7 illustrates an example computing device in which example systems and methods, and equivalents, may operate. The example computing device may be a computer 700 that includes a processor 710 and a memory 720 connected by a bus 730. The computer 700 includes an artifact projection logic 740. In different examples, artifact projection logic 740 may be implemented as a non-transitory computer-readable medium storing computer-executable instructions in hardware, software, firmware, an application specific integrated circuit, and/or combinations thereof.

The instructions may also be presented to computer 700 as data 750 and/or process 760 that are temporarily stored in memory 720 and then executed by processor 710. The processor 710 may be a variety of various processors including dual microprocessor and other multi-processor architectures. Memory 720 may include volatile memory (e.g., read only memory) and/or non-volatile memory (e.g., random access memory). Memory 720 may also be, for example, a magnetic disk drive, a solid state disk drive, a floppy disk drive, a tape drive, a flash memory card, an optical disk, and so on. Thus, memory 720 may store process 760 and/or data 750. Computer 700 may also be associated with other devices including other computers, peripherals, and so forth in numerous configurations (not shown).

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A non-transitory computer-readable medium storing computer-executable instructions that when executed by a computer cause the computer to:
generate a first digital object in a virtual space that corresponds to a first artifact in a first physical space;
record attributes of the first artifact using the first digital object as the attributes of the first artifact change over time; and
project, into a second space, a representation of the first artifact, where the representation is generated based on attributes of the first artifact at a first selected time.

2. The non-transitory computer-readable medium of claim 1, where the instructions further cause the computer to:
record interactions with the first artifact over time; and
project the interactions with the first artifact into a second space.

3. The non-transitory computer-readable medium of claim 2, where the interactions projected correspond to the first selected time, and where the first selected time corresponds to a selected prior state of the first artifact.

4. The non-transitory computer-readable medium of claim 1, where the first physical space and the second space are different physical spaces, and where projecting the representation of the first artifact occurs substantially contemporaneously with recording the attributes of the first artifact.

5. The non-transitory computer-readable medium of claim 4, where the instructions further cause the computer to:
generate a second digital object in the virtual space that corresponds to a second artifact in the second space;
record attributes of the second artifact using the second digital object as the attributes of the second artifact change over time; and
project, into the first physical space, a representation of the second artifact, where the representation is generated based on attributes of the second artifact.

6. The non-transitory computer-readable medium of claim 5, where the representation of the second artifact is projected into the first physical space based on attributes of the second artifact at a second selected time.

7. The non-transitory computer-readable medium of claim 1, where the instructions further cause the computer to:
select a suitable location within the second space at which to project the representation of the first artifact.

8. The non-transitory computer-readable medium of claim 7, where the representation of the first artifact is modified to fit in the suitable location within the second space.

9. The non-transitory computer-readable medium of claim 1, where the second space is a virtual rendering of the virtual space.

10. The non-transitory computer-readable medium of claim 1, where the representation of the first artifact is projected into the second space based on one or more of, a gesture command, an oral command, and a command received from an input device.

11. A system, comprising:
a data store to store a first digital space and a first digital object, where the first digital object is associated with a first artifact having a first location in a first physical space, and where the first location corresponds to a first digital location in the first digital space;
an artifact capture logic to identify manipulations made to the first artifact over time, and to store the manipulations as states associated with the first digital object; and
a projection logic to generate a projection of the first artifact at a first projection location, where the projection is generated based on a state associated with the first digital object.

12. The system of claim 11, where the data store stores a second digital object, where the second digital object is associated with a second artifact having a second physical location in a second physical space, where the second physical location corresponds to a second digital location in the first digital space, and where the first digital location and the second digital location preserve a relative spatial relationship between the first artifact and the second artifact.

13. The system of claim 12, where the projection logic generates a projection of the second artifact at a second projection location, where the first projection location and the second projection location preserve the relative spatial relationship between the first artifact and the second artifact.

14. The system of claim 11, where the data store also stores a second digital space, where the first digital space is associated with a first project, where the second digital space is associated with a second project, and where the projection logic is controllable to switch between projections of artifacts associated with the first digital space and projections of artifacts associated with the second digital space.

15. A method, comprising:
storing states and interactions associated with artifacts at locations in a physical space, where the locations in the physical space correspond to digital locations in a virtual space;
receiving a request indicating an artifact and one or more of a state and an interaction; and
projecting, onto a projected location, a replay of the artifact associated with the one or more of the state and the interaction.
